(19) United States
(12) Patent Application Publication
(10) Pub. No.: US 2026/0112076 A1
(43) Pub. Date: Apr. 23, 2026

(54) ELUCIDATED DIFFUSION NOISE ROLLING FOR LONG-RANGE FORECASTING

(71) Applicant: NVIDIA Corporation, Santa Clara, CA (US)

(72) Inventors: Salva Rühling Cachay, San Diego, CA (US); Morteza Mardani, San Jose, CA (US); Miika Samuli Aittala, Helsinki (FI); Noah Brenowitz, Seattle, WA (US); Karsten Julian Kreis, Vancouver (CA); Arash Vahdat, San Mateo, CA (US)

(21) Appl. No.: 19/200,151

(22) Filed: May 6, 2025

Related U.S. Application Data
(60) Provisional application No. 63/698,978, filed on Sep. 25, 2024.

(51) Int. Cl. G06T 11/00; G06T 5/60; G06T 5/70

(52) U.S. Cl. CPC G06T 11/00; G06T 5/60; G06T 5/70; G06T 2207/20076; G06T 2207/20081; G06T 2207/20084

(57) ABSTRACT

Apparatuses, systems, and techniques for probabilistic forecasting. In at least one embodiment, a neural network is configured to receive an input frame indicating a current status, and obtain, based on the input, a sequence of first frames to form a first processing window. The first frames in the sequence are corrupted with one or more predefined noise schedules. The neural network is configured to further denoise the sequence of first frames within the first processing window simultaneously to produce a sequence of second frames, output one or more second frames from the first processing window, and form a second processing window by appending one or more additional frames to the remaining one or more second frames from the first processing window. As such, the neural network produces output frames based on a rolling processing window.

### CLAIM OF PRIORITY

This application claims the benefit of U.S. Provisional Application No. 63/698,978 titled “Elucidated Diffusion Noise Rolling For Long-Range Forecasting,” filed Sep. 25, 2024, the entire contents of which are incorporated herein by reference.

### BACKGROUND

Probabilistic dynamics forecasting is an advanced approach to predicting future outcomes that accounts for inherent uncertainties in complex systems. Unlike deterministic forecasting, which aims to provide a single outcome prediction, probabilistic dynamics forecasting generates a range of potential outcomes with associated probabilities. Probabilistic dynamics forecasting is particularly useful in high-variability environments, e.g., weather prediction, financial markets, and supply chain management.

Diffusion models have emerged as a particularly powerful paradigm for synthesizing complex data, demonstrating remarkable success in generating high-quality images, audio, and text. However, conventional diffusion models struggle to effectively address unique challenges presented by modeling complex temporal data (e.g., in fluid dynamics and climate data). Deterministic models, e.g., are unsuitable for uncertainty quantification, prone to producing unrealistic or blurry predictions, and suffer instability for long-range forecasting. Probabilistic models, on the other hand, typically assume a Markovian framework, neglect the sequential nature of the data, and fail to account for uncertainty in long-range predictions being inherently higher than that for short-range predictions.

Rolling Video Diffusion Models (RVDMs) have demonstrated promise in overcoming shortcomings of conventional deterministic and probabilistic diffusion models. RVDMs provide time-dependent noise levels, creating a sliding window denoising process that progressively corrupts data over time. While this approach allows for increasing uncertainty of future states while simultaneously maintaining temporal coherence and enabling indefinite sequence generation, a number of limitations hamper its effectiveness in domains that exhibit (i) data scarcity and (ii) multi-scale and chaotic processes.

### BRIEF DESCRIPTION OF THE DRAWINGS

The present systems and methods for elucidated diffusion noise rolling for long-range forecasting are described in detail below with reference to the attached drawing figures, wherein:

FIG. 1A illustrates a flowchart of a method for training a diffusion model, in accordance with certain embodiments.

FIG. 1B provides flow diagrams illustrating an example training scheme, in accordance with certain embodiments.

FIG. 1C provides a graph that shows an example distribution of noise applied to the images within a window, in accordance with an embodiment.

FIG. 1D is a block diagram illustrating a network architecture, in accordance with certain embodiments.

FIG. 1E is a block diagram illustrating noise embedding, in accordance with an embodiment.

FIG. 2A illustrates a flowchart of a method for weather forecasting, in accordance with certain embodiments.

FIG. 2B illustrates an example of rolling window forecasting, in accordance with one embodiment.

FIG. 3 is a graph illustrating noise schedules and denoising steps, in accordance with an embodiment.

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Systems and methods are disclosed herein that relate to elucidated diffusion noise rolling for long-range forecasting, and in particular, to neural network architectures and machine learning processes that support enhanced probabilistic forecasting.

In one or more embodiments, a diffusion model is trained for modeling sequential data with progressively increasing noise levels. In at least one embodiment, the diffusion model is configured to predict outputs using a rolling window that includes one or more temporally sequential frames with progressively increasing noise levels. The diffusion model concurrently denoises the frames within the rolling window while leveraging the temporal relationships between frames, thereby producing one or more “clean” frames. For long-range forecasting, the denoising is performed iteratively, and the one or more clean frames produced in one iteration exit the rolling window for the subsequent iteration.

In one or more embodiments, the sequence of frames within the rolling window is subjected to gradient noises. In at least one embodiment, the gradient noises are represented by a noise vector, with each element parameterizing a noise level applied to a specific frame within the rolling window. The noise vector is a highly generalized noise schedule that encompasses a broad design space, including convex, concave, and other suitable noise schedules.

In one or more embodiments, the diffusion model is used to perform probabilistic dynamics forecasting. In at least one embodiment, the diffusion model is used for predicting weather data, represented by temporally sequential frames, on a rolling basis.

In one or more embodiments, the diffusion model employs a bespoke hybrid architecture that integrates temporal attention and embeds highly generalized, frame-dependent noise schedules. This design enables effective modeling of sequential data with progressively increasing noise levels. The approach supports reuse of standard frameworks on a per-frame basis, requiring only the addition of temporal layers to capture inter-frame interactions. Furthermore, the architecture accommodates training and sampling with variable window sizes and supports a machine learning workflow that includes both pretraining and post-training (or fine-tuning) phases. Compared to existing techniques, the diffusion model adopts a modern diffusion formulation with distinct choices for the noise schedule, training objective, and sampling strategy during inference, contributing to improved performance and training efficiency. Training is divided into two stages: unconditional image pretraining followed by rolling temporal diffusion training, supported by a tailored three-dimensional (3D) neural network architecture designed to model temporal dependencies effectively. In at least one embodiment, the first window of frames is initialized using an external prediction model, allowing the diffusion model to focus exclusively on the denoising task. This separation helps reduce complexity, alleviate capacity bottlenecks, and minimize the need for additional hyperparameter tuning. With this design, the diffusion model effectively addresses challenges posed by data scarcity and multi-scale or chaotic processes, overcoming limitations that hinder existing technologies, while providing enhanced performance in increasing uncertainty of future states, achieving temporal coherence, and enabling indefinite sequence generation.

A method is provided for probabilistic forecasting, which includes: receiving an input frame indicating a current status, and obtaining, based on the input, a sequence of first frames to form a first processing window. In at least one embodiment, the first frames in the sequence are corrupted with one or more predefined noise schedules. The method further includes denoising the sequence of first frames within the first processing window simultaneously to produce a sequence of second frames, each second frame corresponding to a respective first frame of the sequence of first frames, outputting one or more second frames from the first processing window, and forming a second processing window by appending one or more additional frames to the remaining one or more second frames from the first processing window.

According to an embodiment of the method, the sequence of first frames include at least one initial first frame. In at least one embodiment, the one or more other first frames within the first processing window are generated based on the at least one initial first frame and the one or more predefined noise schedules.

According to an embodiment of the method, the one or more predefined noise schedules leads to progressively increasing noise levels applied to the sequence of first frames.

According to an embodiment of the method, the one or more predefined noise schedules are determined based on a preset noise range and an offset corresponding to a time point associated with each frame within a corresponding processing window.

According to an embodiment of the method, the one or more predefined noise schedules are represented by elements in a noise vector. In at least one embodiment, the denoising is performed by a diffusion model. In at least one embodiment, the diffusion model includes an input scaling factor, an output scaling factor, and a skip scaling factor. In at least one embodiment, the input scaling factor, the output scaling factor, and the skip scaling factor are represented by respective vectors determined based on the noise vector.

According to an embodiment of the method, the denoising is performed by a diffusion model. In at least one embodiment, the diffusion model includes one or more layers that implement a separate time dimension corresponding to the size of the processing window. In at least one embodiment, the diffusion model includes one or more layers with dimensions scaled according to the time dimension.

According to an embodiment of the method, the diffusion model is trained through a first stage and a second stage. In at least one embodiment, at the first stage, the diffusion model is trained to denoise individual images corrupted with various levels of noise. In at least one embodiment, at the second stage, the diffusion model is incorporated with one or more temporal layers and trained to denoise a set of sequential images simultaneously, the set of sequential images are corrupted with progressively increasing noise levels, and the size of the image set is associated with the size of the processing window.

According to an embodiment of the method, the diffusion model is an unconditional diffusion model. In at least one embodiment, a second neural network model is trained to generate at least one initial first frame based on the input frame and provide the at least one initial first frame to the diffusion model for generating the other first frames in the sequence of first frames to form the first processing window.

According to an embodiment of the method, denoising the sequence of first frames within the first processing window is performed by a predefined number of iterations to generate the one or more second frames to be output from the first processing window.

According to an embodiment of the method, a sequence of processing windows including the first and second processing windows are formed and subsequently a sequence of denoised frames are output by performing denoising on the sequence of processing windows. In at least one embodiment, the sequence of denoised frames includes the one or more second frames output from the first processing window.

A machine-readable medium is provided having stored thereon a set of instructions, which if performed by one or more processors, cause the one or more processors to perform the method for probabilistic forecasting.

A system is provided for probabilistic forecasting, which includes a neural network. The neural network is configured to receive an input frame indicating a current status, and obtain, based on the input, a sequence of first frames to form a first processing window. In at least one embodiment, the first frames in the sequence are corrupted with one or more predefined noise schedules. The neural network is configured to further denoise the sequence of first frames within the first processing window simultaneously to produce a sequence of second frames, each second frame corresponding to a respective first frame of the sequence of first frames, output one or more second frames from the first processing window, and form a second processing window by appending one or more additional frames to the remaining one or more second frames from the first processing window.

According to an embodiment of the system, the sequence of first frames include at least one initial first frame. In at least one embodiment, the one or more other first frames within the first processing window are generated based on the at least one initial first frame and the one or more predefined noise schedules.

According to an embodiment of the system, the one or more predefined noise schedules leads to progressively increasing noise levels applied to the sequence of first frames.

According to an embodiment of the system, the one or more predefined noise schedules are determined based on a preset noise range and an offset corresponding to a time point associated with each frame within a corresponding processing window.

According to an embodiment of the system, the one or more predefined noise schedules are represented by elements in a noise vector. In at least one embodiment, the denoising is performed by a diffusion model, the diffusion model includes an input scaling factor, an output scaling factor, and a skip scaling factor. In at least one embodiment, the input scaling factor, the output scaling factor, and the skip scaling factor are represented by respective vectors determined based on the noise vector.

According to an embodiment of the system, the denoising is performed by a diffusion model. In at least one embodiment, the diffusion model includes one or more layers that implement a separate time dimension corresponding to the size of the processing window. In at least one embodiment, the diffusion model includes one or more layers with dimensions scaled according to the time dimension.

According to an embodiment of the system, the diffusion model is trained through a first stage and a second stage. In at least one embodiment, at the first stage, the diffusion model is trained to denoise individual images corrupted with various levels of noise. In at least one embodiment, at the second stage, the diffusion model is incorporated with one or more temporal layers and trained to denoise a set of sequential images simultaneously, the set of sequential images are corrupted with progressively increasing noise levels, and the size of the image set is associated with the size of the processing window.

According to an embodiment of the system, the diffusion model is an unconditional diffusion model. In at least one embodiment, a second neural network model is trained to generate at least one initial first frame based on the input frame and provide the at least one initial first frame to the diffusion model for generating the other first frames in the sequence of first frames to form the first processing window.

According to an embodiment of the system, denoising the sequence of first frames within the first processing window is performed by a predefined number of iterations to generate the one or more second frames to be output from the first processing window.

According to an embodiment of the system, a sequence of processing windows including the first and second processing windows are formed and subsequently a sequence of denoised frames are output by performing denoising on the sequence of processing windows, and wherein the sequence of denoised frames includes the one or more second frames output from the first processing window.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

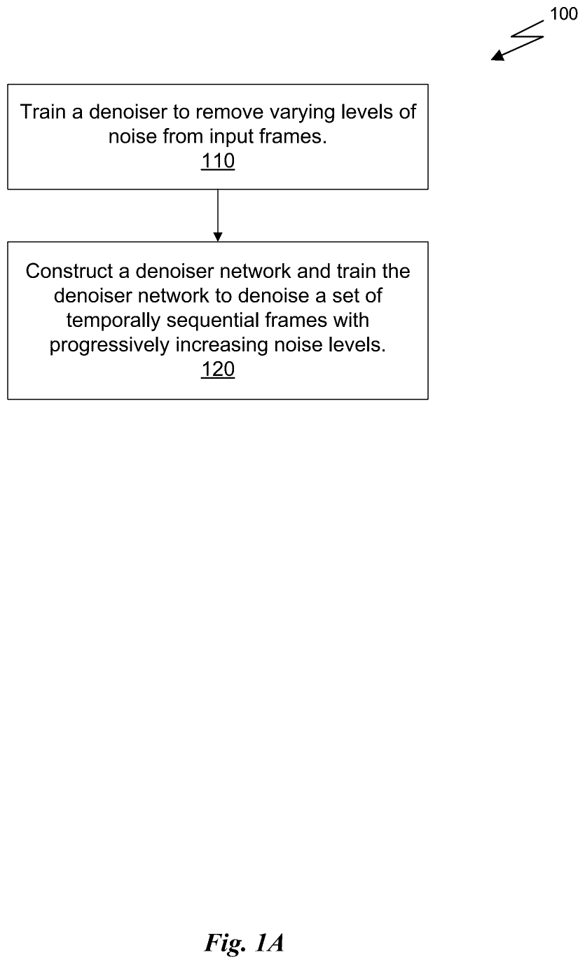

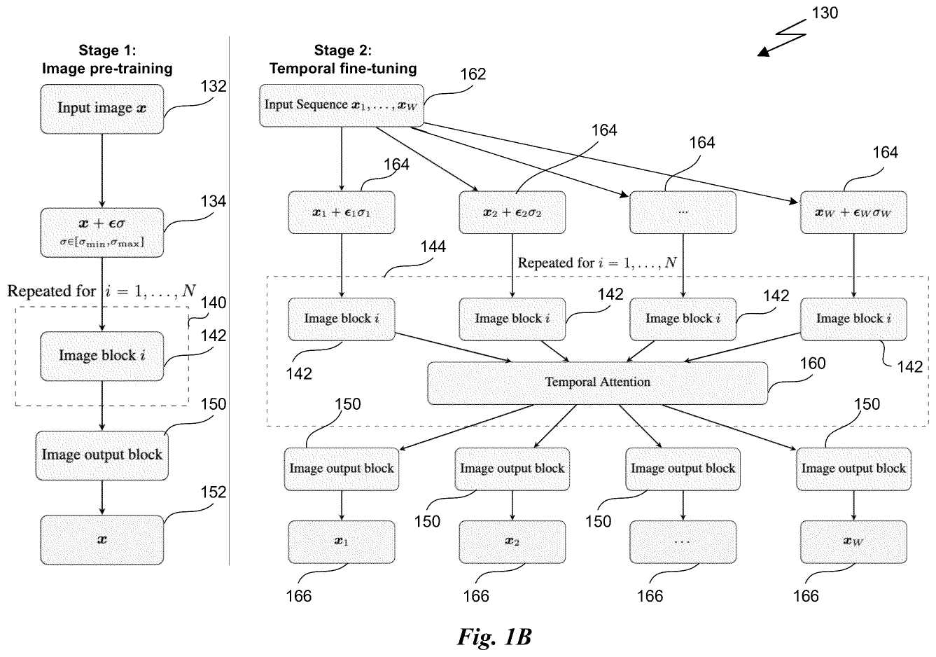

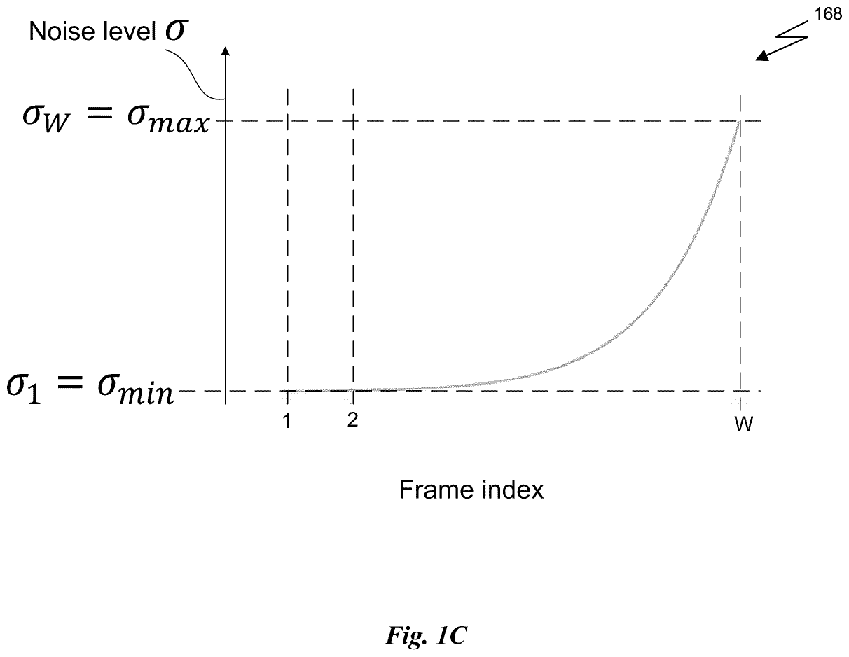

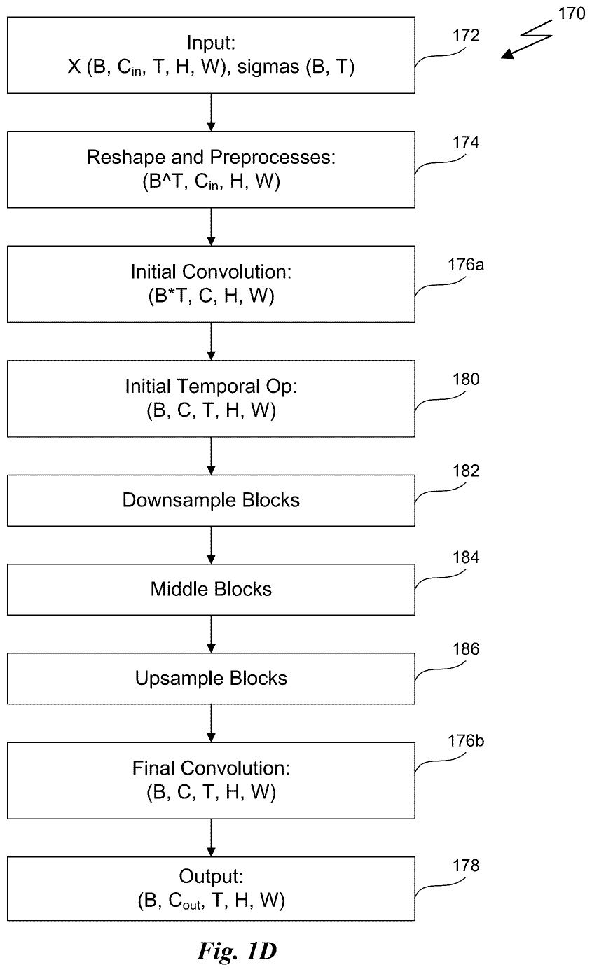

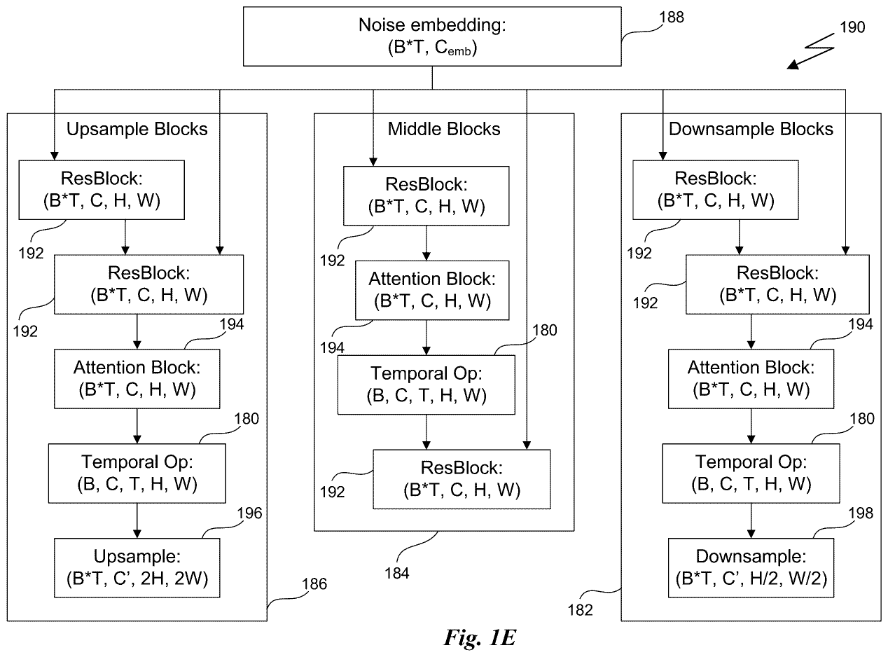

FIG. 1A illustrates a flowchart of a method 100 for training a diffusion model, in accordance with certain embodiments. Each block of method 100, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. Method 100 may be executed by any one system, or any combination of systems, including, but not limited to, those described herein. Furthermore, persons of ordinary skill in the art will understand that any system that performs method 100 is within the scope and spirit of embodiments of the present disclosure.

In at least one embodiment, the diffusion model is constructed as a network of trained denoisers for denoising on a rolling window.

At stage 110, a denoiser is trained to remove varying levels of noise from an input frame. Stage 110 may be referred to as a pretraining stage. In at least one embodiment, the input frame is generated by adding varying levels of noise to a clean frame, and the denoiser is trained to remove the added noise from the clean frame. Each frame (or “image”), which has predefined dimensions (e.g., a specified height and width in pixels), corresponds to a set of parameters, each parameter being represented by a channel (C).

In at least one embodiment, stage 110 utilizes a training dataset that includes a set of ground truth frames, which may include sequential frames that evolve progressively over time. In at least one embodiment, the training dataset includes frames representing weather data, such as weather maps, that evolve over times ranging from a few hours to a day, a week, or even longer. For example, a frame representing weather data has predefined dimensions (e.g., a specified height and weight in pixels, each pixel representing a defined geographic area and thereby corresponding to a particular resolution) and includes a number of channels, each of which provides data pertaining to a weather variable (e.g., temperature, wind speed, radar reflectivity, etc.). During training, each ground truth frame is corrupted with noise at varying levels.

At stage 120, a denoiser network is constructed from a plurality of instances of the unconditional denoiser (i.e., trained at 110), which are expanded to incorporate temporal attention layers, thereby allowing for conditional denoising of frames (i.e., allowing the denoising of one frame to be conditioned on one or more additional frames in a sequence of frames). The denoiser network is then trained to denoise a set of temporally sequential frames with progressively increasing noise levels. Stage 120 may be referred to as a fine-tuning stage.

In at least one embodiment, stage 120 utilizes a training dataset that includes sets of temporally sequential frames that evolve progressively over time. In at least one embodiment, the same dataset used at stage 110 is used at stage 120. The denoiser network is trained (or fine-tuned) to perform simultaneous denoising on a set of temporally sequential frames within a window. The window size corresponds to the number of instances of the trained denoiser in the denoiser network. In at least one embodiment, the denoiser network is trained on image sets of varying sizes. Accordingly, the denoiser network can select from different window sizes during inference. In at least one embodiment, an image set used for training may be larger than the window size used during inference. In at least one embodiment, the window size is associated with a lookahead range (e.g., a specified number of days) in forecasting applications, determining the extent of future data considered for prediction. During training, ground truth sets of temporally sequential frames (corresponding to the window size) are corrupted with progressively increasing noise levels. In at least one embodiment, the noise levels are determined based on a predefined noise schedule.

FIG. 1B provides flow diagrams illustrating an example training scheme 130, in accordance with certain embodiments. Each block of the training scheme 130, described herein, comprises a computing process that may be performed using any combination of hardware, firmware, and/or software. For instance, various functions may be carried out by a processor executing instructions stored in memory. The training scheme 130 may also be embodied as computer-usable instructions stored on computer storage media. The training scheme 130 may be provided by a standalone application, a service or hosted service (standalone or in combination with another hosted service), or a plug-in to another product, to name a few. The training scheme 130 may be executed by any one system, or any combination of systems, including, but not limited to, those described herein. Furthermore, persons of ordinary skill in the art will understand that any system that performs the training scheme 130 is within the scope and spirit of embodiments of the present disclosure.

As shown in FIG. 1B, at the image pre-training stage (or stage 1), a denoiser is trained to denoise individual noisy images from a training dataset. Stage 110 of method 100 corresponds to stage 1 of training scheme 130.

At block 132, an input image (x) is sampled from the training dataset.

At block 134, the input image (x) is corrupted by an amount of noise (ϵσ), expressed as: x+ϵσ, where ϵ˜ [symbol] (0, I) represents Gaussian noise and σ represents a scaling factor corresponding to noise level. The scaling factor (σ) is sampled between a lower limit (σₘᵢₙ) and an upper limit (σₘₐₓ), expressed as: σ∈[σₘᵢₙ, σₘₐₓ]. In at least one embodiment, varying levels of noise are generated and applied to the input image (x).

At block 140, a set of image blocks perform denoising on the corrupted input image. In this example, the set of image blocks include N number of image blocks 142, with each image block being any of a downsample, a middle, or an upsample block, as depicted in FIG. 1D or 1E. Each image block 142 is configured to perform one or more image-based operations, which operate only on spatial dimensions of the input and ignore the temporal dimension. In at least one embodiment, at block 140, the denoiser performs denoising by sequentially applying the i-th image block 142, where i ranges from 1 to N.

At block 150, the image output block 150 processes results from the block 140 to produce a denoised image (also referred to as a clean image/frame) at block 152.

In at least one embodiment, a loss is computed based on the difference between the ground truth image and the predicted clean image for a batch of images. The batch of images may consist of the entire training dataset or a subset thereof. Learnable weights in the denoiser are updated based on the loss. In at least one embodiment, the denoiser output from stage 1 can denoise a plurality of noise levels at every time point corresponding to the sequential images in the training dataset.

In some embodiments, the denoiser may include one or more residual blocks.

In at least one embodiment, the denoiser utilizes one or more network layers to execute block 150, which learn to map the internal representations (features) generated by the preceding layers, such as those executing block 140, to the final output (such as an image).

At the temporal fine-tuning stage (or stage 2), a denoising network is constructed by incorporating temporal attention 160 into the denoiser output from stage 1. In at least one embodiment, the temporal attention 160 is facilitated by incorporating one or more temporal attention layers. The one or more temporal attention layers incorporate the time dimension, corresponding to the window size, into the denoising network, enabling modeling of temporal interactions between frames. In at least one embodiment, the one or more temporal attention layers are interleaved with the other network layers in the denoising network.

At this stage, the denoising network is trained to process a sequence of input images at each step. In this example, the second denoising network receives a number W of temporally sequential images as input and concurrently denoises the W images, where W is the window size. The temporally sequential images within the window are corrupted with a noise gradient.

At block 162, a sequence of images are sampled from the training dataset, denoted as: x₁, . . . , x_{W}.

At blocks 164, the sequence of images are corrupted by varying levels of noise. The noise added to the sequence of images is denoted as: ϵ₁σ₁, ϵ₂σ₂, . . . , σ_{W}σ_{W}. As such, the sequence of corrupted images are expressed as: x₁+ϵ₁σ₁, X₂+ϵ₂σ₂, . . . , x_{W}+ϵ_{W}σ_{W}.

In at least one embodiment, noise is added with a time-dependent schedule specific to each lead time (corresponding to a frame index ω) in a forward diffusion process. The noise schedule is denoted by σ_{ω}(t) for each frame (ω), where σ_{ω}(t) is a monotonically increasing function of time (t). In at least one embodiment, the forward SDE can be expressed as: dx=\sqrt{\dot{τ}ₜ}dω(t), where Σₜ is a diagonal matrix with elements

$${σ}_{ω}^{2} ( t )$$

for ω=1, . . . , W, and \dot{Σ}ₜ represents the time derivative of Σₜ. This ensures that the noise added at each step is appropriate for the specific lead time. In at least one embodiment, the diagonal matrix can be formulated as: Σₜ=σ²(t)Q for a time-independent diagonal weighting matrix ( [symbol] ).

In at least one embodiment, a local time

$${t}_{ω} = 1 - \frac{ω - offset}{W}$$

is used for each frame (or image) separately, where the frame is indexed by ω=1, . . . , W. As such, the local noise level of frame ω is

$${σ}_{ω} = {( {σ}_{m ax}^{\frac{1}{ρ}} + {t}_{ω} ( {σ}_{m i n}^{\frac{1}{ρ}} - {σ}_{m ax}^{\frac{1}{ρ}} ) )}^{ρ} ,$$

where σₘᵢₙ, σₘₐₓ, and ρ are hyperparameters that can be chosen at training time. The “1−” term is implemented so that near-future frames (e.g., ω=1) receive minimal noise (σ₁≈σₘᵢₙ), while far-future frames (e.g. ω=W) receive high levels of noise (σ_{W}≈σₘₐₓ). FIG. 1C provides a graph 168 that shows an example distribution of noise applied to the images within the window, in accordance with an embodiment.

In the denoising network, the denoiser from stage 1 is replicated W times to initialize the denoiser network. At block 144, a plurality of replicas (or instances) of the set of image blocks 142 are executed to denoise the sequence of corrupted images from blocks 164, in conjunction with the temporal attention at block 160. In at least one embodiment, block 160 includes one or more temporal operations. In at least one embodiment, at block 144, for each index i ranging from 1 to N, the plurality of instances of the corresponding i-th image block 142 are executed in parallel to perform image-based operations on the input images, and block 160 is applied in conjunction with the instances of the i-th image block 142 to incorporate temporal attention. After denoising, a plurality of replicas (or instances) of block 150 are executed, with each instance of block 150 corresponding to an instance of a set of N image blocks 142. At blocks 166, the instances of block 150 output a sequence of clean images.

In at least one embodiment, a loss is computed based on the difference between the sequence of ground truth images at block 162 and the sequence of clean images at blocks 166. Learnable weights in the denoising network, including those in the layers executing blocks 144, 160, 150, and/or other relevant layers, are updated based on the loss. In at least one embodiment, the denoising network is trained to denoise the sequential images within the window both independently and jointly.

Table 1 illustrates an algorithm (denoted as Algorithm 1) for training, in accordance with at least one embodiment. Algorithm 1 illustrates an example of training stage 2 using an unconditional diffusion model (e.g., the denoiser trained from stage 1). As shown in Algorithm 1, the training dataset is denoted as Dₜᵣ, which includes sequential frames at N time points corresponding to progression of a sample x. The diffusion model is denoted as Fe, where θ represents the learnable weights in the model. The diffusion model is trained to process, at each time, with a window size (W).

TABLE 1
Algorithm 1 for training

```
  1: Require: [symbol]  := {x₁, ... , x_{N}}, x ∈ [symbol] , F_{θ}
  2: repeat
  3: Sample x_{clean} = (x¹, ... , x^{W}) from [symbol] , ϵ~ [symbol]  (0, 1), t~U(0, 1)
  4: σ ← NoiseScheduleRDM(W, offset = t)
  5: x_{noisy} ← x_{clean} + σ · ϵ
  6: xᵢₙ ← cᵢₙ(σ)x_{noisy}
  7: x_{denoised} ← cₛₖᵢₚ(σ)x_{noisy} + cₒᵤₜ(σ)F_{θ}(xᵢₙ, t)
  $8 : Update θ using {L}_{θ} = \frac{1}{W} {\sum }_{ω = 1}^{W} {λ ( σ )}_{ω} {‖ {x}_{clean}^{ω} - {x}_{d enoised}^{ω} ‖}_{2}^{2}$
  9: until Converged
10: procedure NoiseScheduleEDM (s)
$11 : return {( {σ}_{m ax}^{\frac{1}{ρ}} + s ( {σ}_{m i n}^{\frac{1}{ρ}} - {σ}_{m ax}^{\frac{1}{ρ}} ) )}^{ρ}$
12: procedure NoiseScheduleRDM (W, offset)
$13 : return [ NoiseScheduleEDM ( 1 - \frac{j - offset}{W} ) for j ∈ \{ 1 , 2 , … , W \} ]$
```

In Algorithm 1, a rolling diffusion model (RDM) is constructed based on an elucidated diffusion model (EDM). Specifically, as a noise level vector (σ) is utilized in the RDM, a set of scaling vectors are defined with respect to the noise level vector (σ). This vectorization approach used in the RDM extends EDM's preconditioning choices by vectorizing them, which leads to improved training dynamics and enhanced forecasting performance. For example, cₛₖᵢₚ(σ) represents skip scaling, formulated as:

$${c}_{skip} ( σ ) = {σ}_{data}^{2} / ( {σ}^{2} + {σ}_{data}^{2} ) .$$

cₒᵤₜ(σ) represents output scaling,

$${c}_{out} ( σ ) = σ \cdot {σ}_{data} / \sqrt{{σ}_{data}^{2} + {σ}^{2}} \cdot {c}_{i n} ( σ )$$

represents input scaling, formulated as:

$${c}_{i n} ( σ ) = 1 / \sqrt{{σ}^{2} + {σ}_{data}^{2}} \cdot {F}_{θ}$$

represents raw neural network layers, where θ represents learnable weights therein. σ_{data} is a hyperparameter in the neural network. In RDM, the denoiser is defined as:

$${D}_{θ} ( {x}_{noisy} ; σ ) = {c}_{skip} ( σ ) {x}_{noisy} + {c}_{out} ( σ ) {F}_{θ} ( {c}_{i n} ( σ ) {x}_{noisy} , t ) , \qquad ( Eq . 1 )$$

where σ is a vector of size W representing the noise level of each frame within the window, cₛₖᵢₚ, cᵢₙ, and cₒᵤₜ are vectors corresponding to the noise level vector (σ). The RDM feeds the sequence of corrupted frames into the network (F_{θ}), with the sequence of corrupted frames conditioned on the gradient noise levels corresponding to the noise level vector (σ). In other words, the noise conditioning is incorporated into the sequence of corrupted frames. This approach allows the utilization of an unconditional diffusion model to perform the denoising.

A loss function is formulated as:

$${L}_{θ} = \frac{1}{W} {\sum }_{ω = 1}^{W} {λ ( σ )}_{ω} {‖ {x}_{clean}^{ω} - {x}_{denoised}^{ω} ‖}_{2}^{2} , \qquad ( Eq . 2 )$$

where λ(σ) represents noise-level weighting. In at least one embodiment, the noise-level weighting is formulated as:

$$λ ( σ ) = ( {σ}^{2} + {σ}_{data}^{2} ) / {( σ \cdot {σ}_{data} )}^{2} .$$

A loss is computed based on the difference between the input sequence of clean frames

$$( {x}_{clean}^{ω} )$$

and the output sequence of denoised frames

$$( {x}_{denoised}^{ω} )$$

using Equation 2. The learnable weights in the network (Fe) are updated based on the loss.

FIG. 1D is a block diagram illustrating a network architecture 170, in accordance with certain embodiments. An example of noise embedding is illustrated in FIG. 1E, in accordance with an embodiment. Each block of the network architecture 170, described herein, comprises a computing process that may be performed using any combination of hardware, firmware, and/or software. For instance, various functions may be carried out by a processor executing instructions stored in memory. The network architecture 170 may also be embodied as computer-usable instructions stored on computer storage media. The network architecture 170 may be provided by a standalone application, a service or hosted service (standalone or in combination with another hosted service), or a plug-in to another product, to name a few. The network architecture 170 may be executed by any one system, or any combination of systems, including, but not limited to, those described herein. Furthermore, persons of ordinary skill in the art will understand that any system that performs the network architecture 170 is within the scope and spirit of embodiments of the present disclosure.

As shown in FIG. 1D, the network architecture 170 includes a plurality of network layers configured to facilitate various functions. In the network architecture 170, “B” denotes the batch size, “T” denotes the time steps (or the time dimension), “C” denotes the channels (corresponding to variables involved in the probabilistic dynamic process), “H” denotes the height, and “W” denotes the width. Cn represents the number of input channels (e.g., the number of feature maps or channels in the input layer), while Cₒᵤₜ represents the number of output channels (e.g., the number of feature maps or channels in the output of a convolutional layer). In at least one embodiment, the network architecture 170 further includes an output block 178 configured to produce output images based on the results from the preceding layers in the network architecture 170. In at least one embodiment, the image output block 150 as shown in FIG. 1B includes the output block 178.

Blocks 180 represent one or more temporal layers (e.g., the “Temporal Op” blocks), which are incorporated at various stages in the network architecture 170, such as before the downsample blocks 182, as well as within the downsample blocks 182, the middle blocks 184, and the upsample blocks 186. FIG. 1E is a block diagram 190 illustrating noise embedding, in accordance with an embodiment. Block 188 represents the noise vector to be embedded into the network architecture 170. The noise vector includes a set of sigma values. In at least one embodiment, the noise vector is represented by C_{emb}.

In FIG. 1D, the network architecture 170, block 172 receives a set of input images (x₁, . . . , x_{T}) and a noise vector that includes a set of sigma values (σ_{T}, . . . , σ_{T}). Block 174 reshapes and preprocesses the input from block 172. Blocks 176a and 176b include one or more convolution layers. Referring to FIG. 1E, the downsample blocks 182, the middle blocks 184, and the upsample blocks 186 may include one or more residual blocks (“ResBlock”) 192, at least one attention block 194, and at least one temporal Op block 180. In at least one embodiment, the upsample blocks 186 further includes one or more upsample layers in block 196, and the downsample blocks 182 further includes one or more downsample layers in block 198. In at least one embodiment, block 188 is incorporated into residual blocks 192 (e.g., the first and second residual blocks 192 in the upsample blocks 186, the middle blocks 184, and the downsample blocks 182). In certain blocks in the network architecture 170, such as blocks 174, 176a, 192, 194, 196, and 198, the time dimension (T) is merged with the batch size (B).

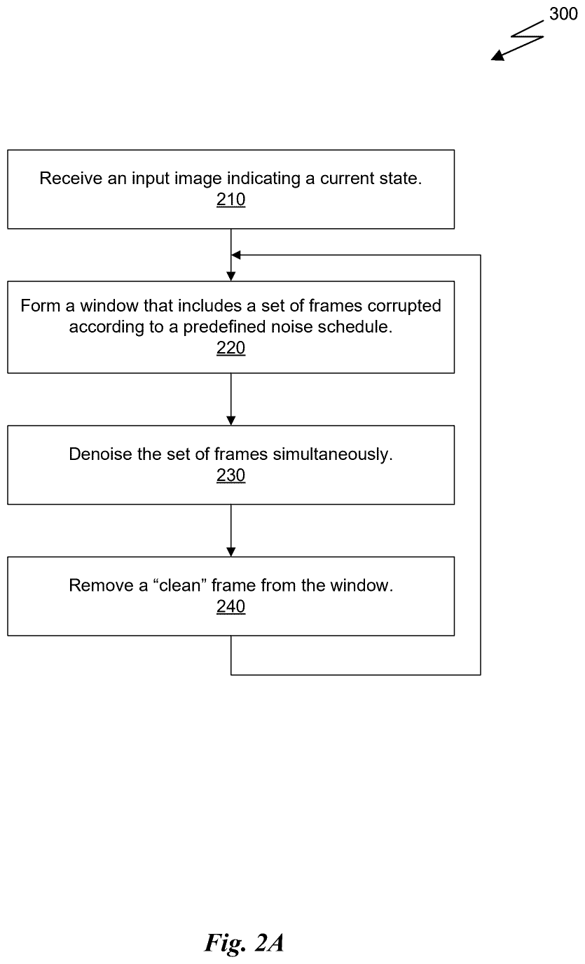

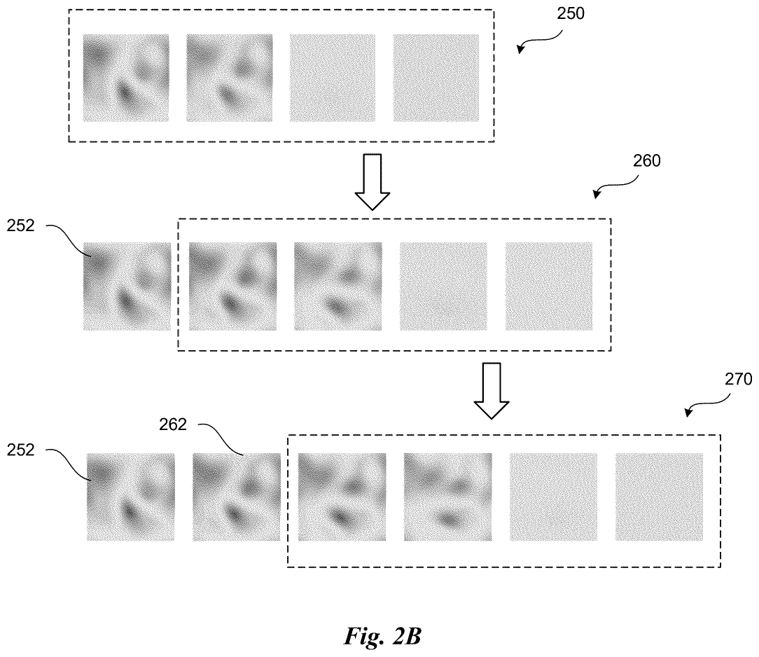

FIG. 2A illustrates a flowchart of a method 200 for weather forecasting, in accordance with certain embodiments. Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. Method 200 may be executed by any one system, or any combination of systems, including, but not limited to, those described herein. Furthermore, persons of ordinary skill in the art will understand that any system that performs method 200 is within the scope and spirit of embodiments of the present disclosure.

The method 200 can be performed using a diffusion model obtained through training with method 100, as illustrated in FIG. 1A. In at least one embodiment, the diffusion model is obtained by executing the training scheme 130 shown in FIG. 1B, following the stages outlined in method 100. Additionally, in at least one embodiment, the diffusion model utilizes the network architecture 170, as illustrated in FIG. 1C.

To illustrate as an example, the method 200 is described with reference to a weather forecasting process. However, the method 200 can be applied to other probabilistic dynamic processes.

At stage 210, the diffusion model receives an input image indicating a current state. For example, the diffusion model receives an input image representing today's weather data.

At stage 220, the diffusion model forms a window that includes a set of frames corrupted according to a predefined noise schedule. In at least one embodiment, a pretrained model is used to predict one or more sequential frames based on the input image. The pretrained model may be a conditional diffusion model, a deterministic model, or another suitable type. In some examples, the conditional diffusion model may be an autoregressive diffusion model. In some instances, the conditional diffusion model is an off-the-shelf conditional diffusion model that predicts one or more temporally sequential frames based on the input image. In an embodiment, a single-step conditional EDM, which operates autoregressively, predicts one frame per step by adding rolling noise to the input, generating four frames to form the first frame set. The diffusion model then applies the predefined noise schedule to the temporally sequential frames to construct the first window for denoising. The predicted sequential images within the window are corrupted with progressively increasing noise levels corresponding to the predefined noise schedule. For example, the noise schedule is represented by a noise vector (σ), which may include a set of sigma values (σ₁, . . . , σ_{T}).

In at least one embodiment, unconditional diffusion models are used for prediction using a rolling window. When using an unconditional diffusion model, another neural network may be pretrained to provide one or more initial predicted frames to the unconditional diffusion model. In at least one embodiment, the unconditional diffusion model may generate one or more additional frames, each with progressively increasing noise levels, which are appended to the received first predicted frame(s) to form the first window for processing. The first frame predicted by the other neural network can be used by the unconditional diffusion model during both the training and inference stages.

At stage 230, the diffusion model denoises the set of frames simultaneously. In at least one embodiment, the denoising is performed for a predefined number of iterations for each window.

At stage 240, the diffusion model removes a “clean” frame from the window. The clean frame is a denoised frame that exits from the current window.

Subsequently, the diffusion model moves back to stage 220 to form a second window, for example, by appending a new noisy frame as the futuremost frame to the three sequential frames from the first window. In at least one embodiment, the new noisy frame is constructed from pure noise. In at least one embodiment, the new noisy frame is generated by adding a high level of noise to a base frame. For example, the noise may be proportional to the maximum noise range (σₘₐₓ). The base frame may be any suitable frame, such as a random image frame or a frame predicted by the diffusion model. Then, the diffusion model continues to stage 230 to denoise the frames within the second window to output the next “clean” frame at stage 240. The diffusion model repeats stages 220 through 240 to continuously roll the window, allowing for ongoing processing and output of “clean” frames as forecasting results.

FIG. 2B illustrates an example of rolling window forecasting, in accordance with one embodiment. As shown in FIG. 2B, the window is represented by the dashed boxes. Arrow 250 indicates the first step, which involves processing the initial window (e.g., the first window). Arrow 260 indicates the second step, which involves processing the second window. A clean image 252 is produced from the first window. Arrow 270 indicates the third step, which involves processing the third window. A clean image 262 is produced from the second window.

Table 2 illustrates an algorithm (denoted as Algorithm 2) for using a trained model during inference, in accordance with at least one embodiment. To illustrate as an example, the diffusion model obtained by performing Algorithm 1 is used during inference.

TABLE 2
Algorithm 2 for inference

```
  1: procedure: DENOISE (x, t)
  2: σ ← NoiseScheduleRDM (offset = frac(t))
  3: x_{noisy} ← x_{└t┘:└t┘} + W
  4: xᵢₙ ← cᵢₙ(σ)x_{noisy}
  5: x_{denoised} ← cₛₖᵢₚ(σ)x_{noisy} + cₒᵤₜ(σ)F_{θ}(xᵢₙ, frac(t))
  6: x_{noisy} ← [x_{└t┘:└t┘}, x_{denoised}] [symbol]  Keep original values for past frames. If t < 1, the
  operation does nothing.
  7: return x_{noisy}
  8: procedure: SAMPLE (x_{clean}, churn = 0, step = 1, heun = True, yield_denoised = False)
```

| | |
|---|---|
| 9: | [symbol] Assume that prompt has shape (B, C, T, H, W), where T is the |

time/frame dimension of size seq_len.
10: Initialize random generators and parameters
$11 : step\_ode ← \frac{step}{1 - churn}$
12: padding ← └step_ode┘ + 1
13: x_{clean} ← pad(x_{clean}, pre = 0, post = padding) [symbol] Pad most future frames to prompt
14: σᵢₙᵢₜ ← NoiseScheduleRDM(offset = 0.0) [symbol] Frame-dependent noise variances
15: Sample ϵ~ [symbol] (0, I),
16: x₀ ← x_{clean} + ϵ · σᵢₙᵢₜ [symbol] Initialize window with rolling noise
17: t₀ ← 0
18: while True do
19: t₁ ← t₀ + step_ode [symbol] Step after churn
20: t₂ ← t₀ + step [symbol] Step after backtracking from churn, if enabled (t₂ ≤ t₁)
21: σₜ_{₀} ← NoiseScheduleRDM (offset = t₀) [symbol] Current noise levels
22: σₜ_{₁} ← NoiseScheduleRDM (offset = t₁) [symbol] Noise levels before churn. If churn = 0,
same as σₜ_{₂}.
23: σₜ_{₂}← NoiseScheduleRDM (offset = t₂) [symbol] Frame-dependent noise levels at the end
of this iteration.
24: Dx₀ ← denoise(x₀, t₀)
$25 : {x}_{1} ← \frac{{σ}_{{t}_{1}}}{{σ}_{{t}_{0}}} {x}_{0} + ( 1 - \frac{{σ}_{{t}_{1}}}{{σ}_{{t}_{0}}} ) {Dx}_{0} Same as {Dx}_{0} + {σ}_{{t}_{1}} ϵ + \frac{{σ}_{{t}_{1}}}{{σ}_{{t}_{0}}} ( {x}_{clean} - D {x}_{0} ) for first step .$
26: if heun then
27: Dx₁ ← denoise(x₁, t₁)
28: d ← (x₀ − Dx₀)/σₜ_{₀}
29: d′ ← (x₁ − Dx₁)/σₜ_{₁}
30: x₁ ← x₀ + (σₜ_{₁} − σₜ_{₀}) · (d + d′)/2
31: if churn > 0 then
$32 : {x}_{2} ← {x}_{1} + \sqrt{{σ}_{{t}_{2}}^{2} - {σ}_{{t}_{1}}^{2}} \cdot randn ( {x}_{1} \cdot shape ) Backtracking back to {t}_{2} noise levels ( add noise )$
33: else
34: x₂ ← x₁
35: n_clean ← [t₂] [symbol] For step = 1, this is always 1.
36: if n_{clean} > 0 then
37: yield Dx_{0:n}_clean [symbol] Select first frame(s) and return them.
38: x₂ ← x₂_{ₙ}_clean [symbol] Remove finished frames
39: t₂ ← t₂ − n_clean [symbol] Re-adjust corresponding noise level offset
40: σ_{fresh} ← σₜ_{₂} [−n_{clean}:] [symbol] Select new, “pure” noise levels
41: x₂ + [x₂, σ_{fresh} · randn(B, C, n_{clean}, H, W)] [symbol] Add fresh noisy frames to the
futuremost frame
42: x₀ ← x₂ [symbol] Update for next iteration
43: t₀ ← t₂

In Algorithm 2, at line 13, x_{clean} represents a sequence of image frames. At line 16, frame-dependent noise, determined by σᵢₙᵢₜ, is added to the sequence of image frames (x_{clean}), forming the initial sequence of frames for the first window. In at least one embodiment, during inference, σᵢₙᵢₜ is a fixed vector corresponding to the noise levels for each frame (defined by σₘᵢₙ, σₘₐₓ, W, and ρ) in the noise schedule function above. In at least one embodiment, the sequence of image frames (x_{clean}) is predicted by a pretrained neural network. Line 32 indicates the injection of stochasticity into the sampling process by adding noise back to the model's predictions.

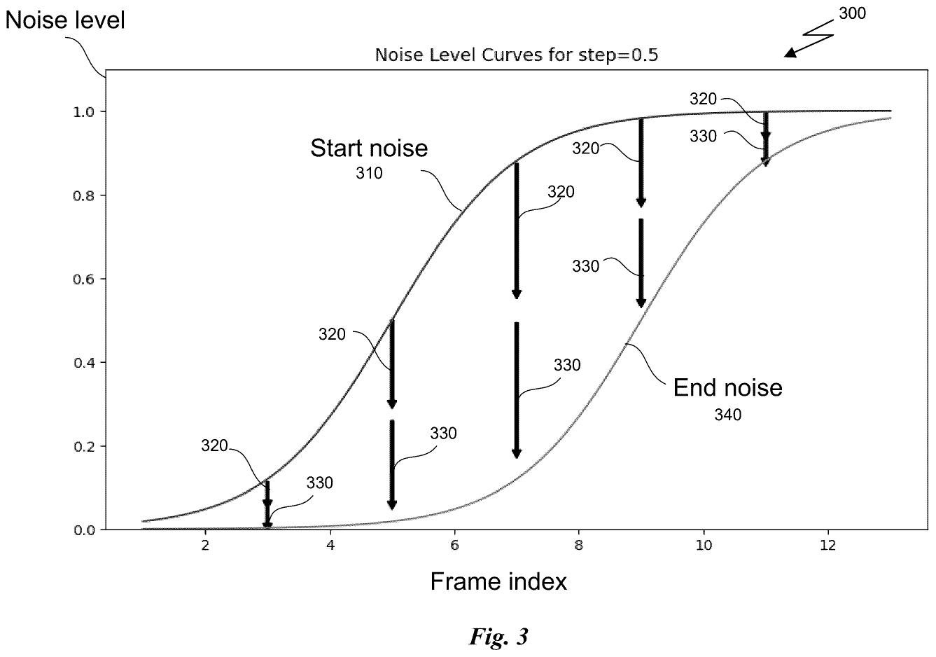

Lines 18-34 in Algorithm 2 correspond to a denoising process involving two steps. FIG. 3 is a graph 300 illustrating noise schedules and denoising steps, in accordance with an embodiment. As shown in FIG. 3, vertical arrows 320 and 330 represent the amount of noise intended to be removed in each denoising step. The start noise curve 310 indicates an initial noise distribution across thirteen frames. Arrows 320 indicates the amount of noise levels reduced by the first denoising step, while arrows 330 indicates the amount of noise levels reduced by the second denoising step. The end noise curve 340 indicates a final noise distribution across thirteen frames. With this configuration, the first frame within the window will be removed from the window after two denoising steps, and the first frame of the subsequent window will be removed after another two denoising iterations, continuing in this manner. As such, it will take 13×2 denoising steps to fully denoise and output thirteen frames.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

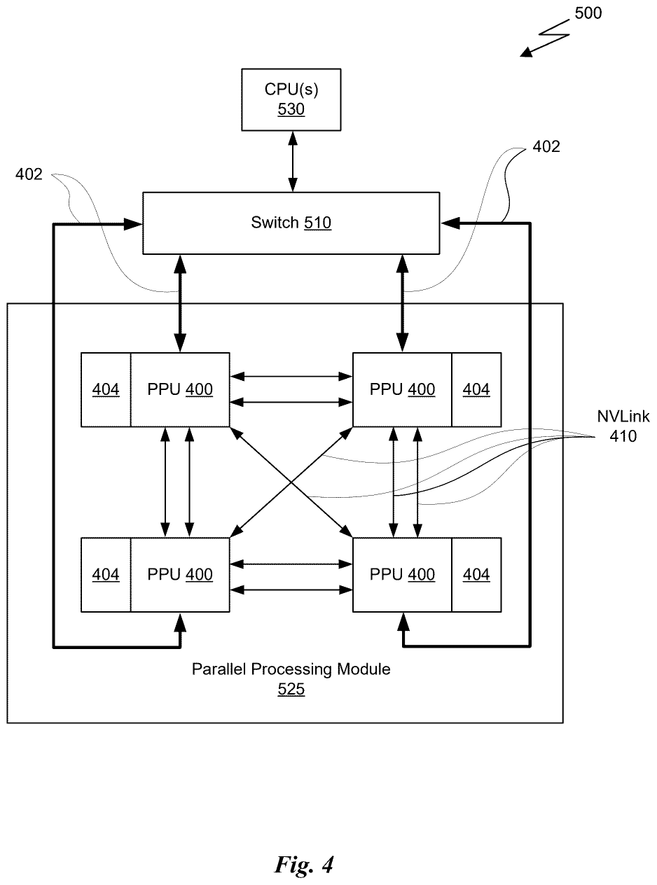

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

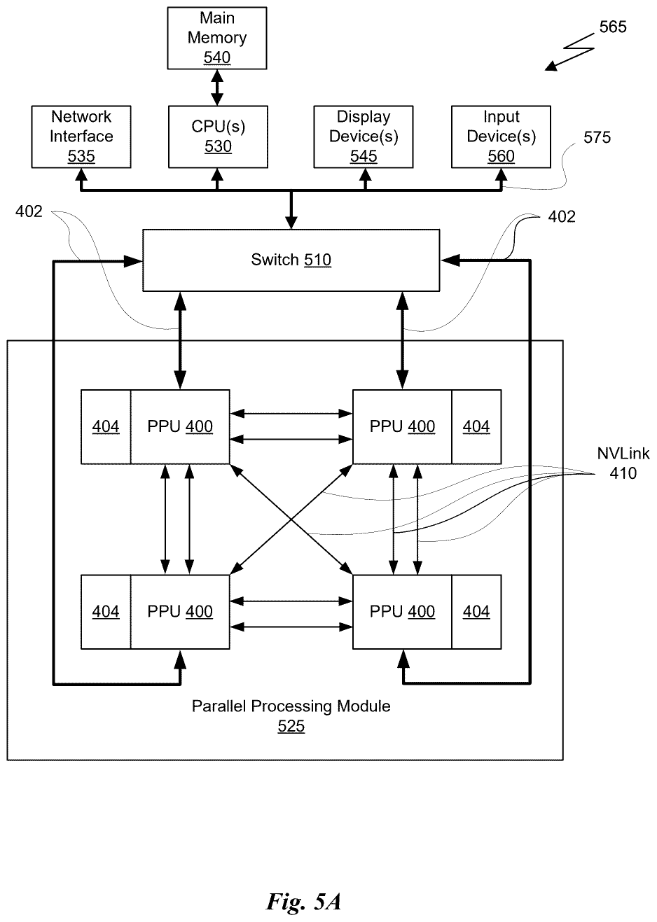

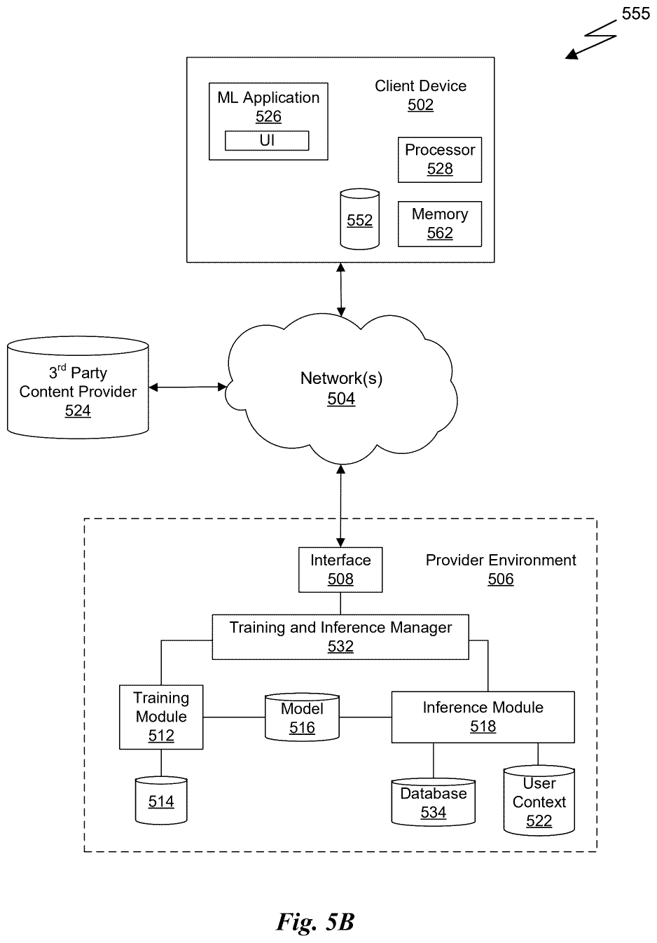

FIG. 5A illustrates an exemplary system 565 in which the various architecture and/or functionality of the various previous embodiments may be implemented. The exemplary system 565 may be configured to implement the method 100 shown in FIG. 1A and/or the method 200 shown in FIG. 2A.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device. MACHINE LEARNING

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA GeForce Now (GFN), Google Stadia, and the like.

### Example Streaming System

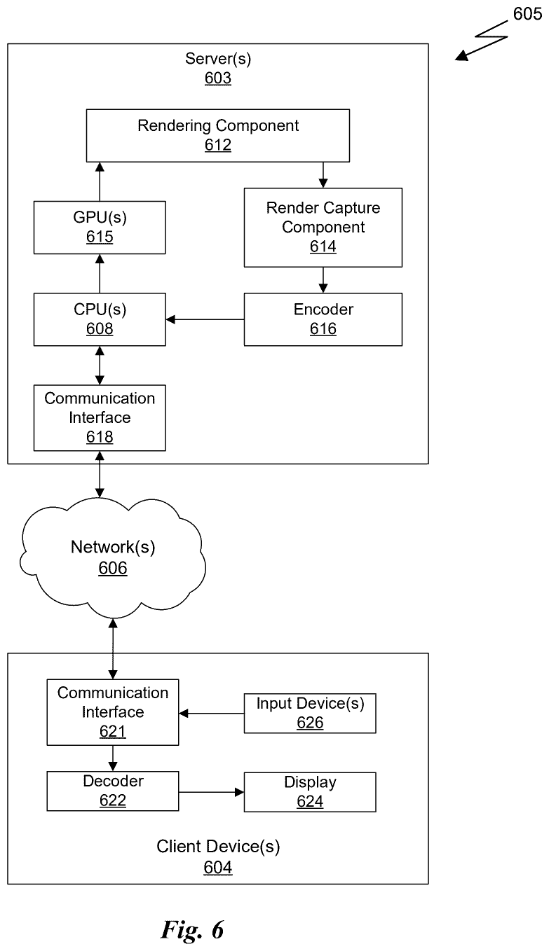

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method for probabilistic forecasting, comprising:
receiving an input frame indicating a current status;
obtaining, based on the input, a sequence of first frames to form a first processing window, wherein the first frames in the sequence are corrupted with one or more predefined noise schedules;
denoising the sequence of first frames within the first processing window simultaneously to produce a sequence of second frames, each second frame corresponding to a respective first frame of the sequence of first frames;
outputting one or more second frames from the first processing window; and
forming a second processing window by appending one or more additional frames to the remaining one or more second frames from the first processing window.

2. The method according to claim 1, wherein the sequence of first frames comprise at least one initial first frame, and wherein the one or more other first frames within the first processing window are generated based on the at least one initial first frame and the one or more predefined noise schedules.

3. The method according to claim 1, wherein the one or more predefined noise schedules leads to progressively increasing noise levels applied to the sequence of first frames.

4. The method according to claim 1, wherein the one or more predefined noise schedules are determined based on a preset noise range and an offset corresponding to a time point associated with each frame within a corresponding processing window.

5. The method according to claim 4, wherein the one or more predefined noise schedules are represented by elements in a noise vector, wherein the denoising is performed by a diffusion model, the diffusion model comprises an input scaling factor, an output scaling factor, and a skip scaling factor, and wherein the input scaling factor, the output scaling factor, and the skip scaling factor are represented by respective vectors determined based on the noise vector.

6. The method according to claim 1, wherein the denoising is performed by a diffusion model, wherein the diffusion model comprises one or more layers that implement a separate time dimension corresponding to the size of the processing window, and wherein the diffusion model comprises one or more layers with dimensions scaled according to the time dimension.

7. The method according to claim 6, wherein the diffusion model is trained through a first stage and a second stage,
wherein at the first stage, the diffusion model is trained to denoise individual images corrupted with various levels of noise, and
wherein at the second stage, the diffusion model is incorporated with one or more temporal layers and trained to denoise a set of sequential images simultaneously, the set of sequential images are corrupted with progressively increasing noise levels, and the size of the image set is associated with the size of the processing window.

8. The method according to claim 6, wherein the diffusion model is an unconditional diffusion model, wherein a second neural network model is trained to generate at least one initial first frame based on the input frame and provide the at least one initial first frame to the diffusion model for generating the other first frames in the sequence of first frames to form the first processing window.

9. The method according to claim 1, wherein denoising the sequence of first frames within the first processing window is performed by a predefined number of iterations to generate the one or more second frames to be output from the first processing window.

10. The method according to claim 1, wherein a sequence of processing windows comprising the first and second processing windows are formed and subsequently a sequence of denoised frames are output by performing denoising on the sequence of processing windows, and
wherein the sequence of denoised frames comprises the one or more second frames output from the first processing window.

11. A system for probabilistic forecasting, comprising:
a neural network configured to:
receive an input frame indicating a current status;
obtain, based on the input, a sequence of first frames to form a first processing window, wherein the first frames in the sequence are corrupted with one or more predefined noise schedules;
denoise the sequence of first frames within the first processing window simultaneously to produce a sequence of second frames, each second frame corresponding to a respective first frame of the sequence of first frames;
output one or more second frames from the first processing window; and
form a second processing window by appending one or more additional frames to the remaining one or more second frames from the first processing window.

12. The system according to claim 11, wherein the sequence of first frames comprise at least one initial first frame, and wherein the one or more other first frames within the first processing window are generated based on the at least one initial first frame and the one or more predefined noise schedules.

13. The system according to claim 11, wherein the one or more predefined noise schedules leads to progressively increasing noise levels applied to the sequence of first frames.

14. The system according to claim 11, wherein the one or more predefined noise schedules are determined based on a preset noise range and an offset corresponding to a time point associated with each frame within a corresponding processing window.

15. The system according to claim 14, wherein the one or more predefined noise schedules are represented by elements in a noise vector, wherein the denoising is performed by a diffusion model, the diffusion model comprises an input scaling factor, an output scaling factor, and a skip scaling factor, and wherein the input scaling factor, the output scaling factor, and the skip scaling factor are represented by respective vectors determined based on the noise vector.

16. The system according to claim 11, wherein the denoising is performed by a diffusion model, wherein the diffusion model comprises one or more layers that implement a separate time dimension corresponding to the size of the processing window, and wherein the diffusion model comprises one or more layers with dimensions scaled according to the time dimension.

17. The system according to claim 16, wherein the diffusion model is trained through a first stage and a second stage,
wherein at the first stage, the diffusion model is trained to denoise individual images corrupted with various levels of noise, and
wherein at the second stage, the diffusion model is incorporated with one or more temporal layers and trained to denoise a set of sequential images simultaneously, the set of sequential images are corrupted with progressively increasing noise levels, and the size of the image set is associated with the size of the processing window.

18. The system according to claim 16, wherein the diffusion model is an unconditional diffusion model, wherein a second neural network model is trained to generate at least one initial first frame based on the input frame and provide the at least one initial first frame to the diffusion model for generating the other first frames in the sequence of first frames to form the first processing window.

19. The system according to claim 11, wherein denoising the sequence of first frames within the first processing window is performed by a predefined number of iterations to generate the one or more second frames to be output from the first processing window.

20. The system according to claim 11, wherein a sequence of processing windows comprising the first and second processing windows are formed and subsequently a sequence of denoised frames are output by performing denoising on the sequence of processing windows, and wherein the sequence of denoised frames comprises the one or more second frames output from the first processing window.

21. A non-transitory computer-readable media storing computer instructions for probabilistic forecasting that, when executed by one or more processors, cause the one or more processors to perform the steps of:
receiving an input frame indicating a current status;
obtaining, based on the input, a sequence of first frames to form a first processing window, wherein the first frames in the sequence are corrupted with one or more predefined noise schedules;
denoising the sequence of first frames within the first processing window simultaneously to produce a sequence of second frames, each second frame corresponding to a respective first frame of the sequence of first frames;
outputting one or more second frames from the first processing window; and
forming a second processing window by appending one or more additional frames to the remaining one or more second frames from the first processing window.

22. The non-transitory computer-readable media according to claim 21, wherein the sequence of first frames comprise at least one initial first frame, and wherein the one or more other first frames within the first processing window are generated based on the at least one initial first frame and the one or more predefined noise schedules.
